(19) United States
(12) Patent Application Publication
(10) Pub. No.: US 2019/0207418 A1
(43) Pub. Date: Jul. 4, 2019

(54) MICROGRID SYSTEM

(71) Applicant: Siemens Aktiengesellschaft, Muenchen (DE)

(72) Inventors: Wei Gang CHEN, Shanghai (CN); Feng DU, Shanghai (CN); Zhen LIU, Shanghai (CN); Thomas BECKERT, Nuernberg (DE); Yue ZHUO, Beijing (CN)

(73) Assignee: Siemens Aktiengesellschaft, Muenchen (DE)

(21) Appl. No.: 16/229,501

(22) Filed: Dec. 21, 2018

(30) Foreign Application Priority Data
Dec. 29, 2017 (CN) 201711484276.1

(51) Int. Cl. H02J 13/00; H02J 3/38; H02J 3/46; H02H 7/22

(52) U.S. Cl. CPC H02J 13/0006; H02J 3/382; H02J 2003/001; H02H 7/22; H02J 3/46

(57) ABSTRACT

The present invention provides a microgrid system. The microgrid system includes a microgrid bus, electrically connected to an external grid; microgrid branches, electrically connected to the microgrid bus; nanogrids, electrically connected to the microgrid branches; and microgrid protection devices, each of the microgrid protection devices including at least one of a protection device connected between the microgrid bus and the external grid, protection devices connected between the microgrid branches and the microgrid bus and protection devices connected between nanogrids and microgrid branches, each of the microgrid protection devices being configured to break at least one of an electrical connection between the microgrid bus and the external grid, electrical connections between the microgrid branches and the microgrid bus and an electrical connections between the nanogrids and the microgrid branches upon at least one of the external grid, the microgrid bus and the microgrid branches malfunctioning.

### PRIORITY STATEMENT

The present application hereby claims priority under 35 U.S.C. § 119 to Chinese patent application number CN 201711484276.1 filed Dec. 29, 2017, the entire contents of which are hereby incorporated herein by reference.

### FIELD

At least one embodiment of the present invention generally relates to a microgrid system.

### BACKGROUND

A microgrid can be a small power generation and distribution system comprising a distributed power supply, an energy storage device, a load, an energy conversion device and a monitoring and protection device. The microgrid usually operates in grid-connected mode in which it is connected with a commercial grid, or in island mode in which it is disconnected from a commercial grid. There are usually a plurality of branches in the microgrid, and each branch is equipped with a protection device, usually including a miniature circuit breaker (MCB).

### SUMMARY

At least one embodiment of the present invention is intended to provide a microgrid system to improve upon or even solve the abovementioned and/or other technical problems.

In an embodiment, the microgrid system comprises a microgrid bus electrically connected to an external grid, microgrid branches electrically connected to the microgrid bus, nanogrids electrically connected to the microgrid branches, and microgrid protection devices, including at least one of a protection device connected between the microgrid bus and the external grid, protection devices connected between the microgrid bus and the microgrid branches and protection devices connected between nanogrids and microgrid branches, and configured to break at least one of the electrical connection between the external grid and the microgrid bus, the electrical connections between the microgrid branches and the microgrid bus and the electrical connections between the nanogrids and the microgrid branches when at least one of the external grid, the microgrid bus and the microgrid branches malfunctions.

### BRIEF DESCRIPTION OF THE DRAWINGS

The following drawings are used only to give an example description and explanation of the present invention, but are not used to limit the scope of the present invention. In the drawings:

FIG. 1A and FIG. 1B are block diagrams for the microgrid systems in example embodiments.

FIG. 2 is a block diagram for a nanogrid in an example embodiment.

FIG. 3 through FIG. 21 are block diagrams for the malfunctions occurring in the microgrid systems in the example embodiments.

### REFERENCE NUMERALS

110: Microgrid bus
130: Microgrid branch
150: Microgrid energy storage unit
170: Nanogrid controller
190: Central controller
210: Nanogrid bus
230: Nanogrid branch
251: Distributed power supply
253: Nanogrid energy storage device
255: Load
PD1, PD2, PD3, PD4, PD6, PD7: Protection devices
NG1, NG2, . . . , NGn: Nanogrids

### DETAILED DESCRIPTION OF THE INVENTION

To understand the technical characteristics, objective, and effects of the present invention more clearly, the embodiments of the present invention are described in the text below in combination with the drawings.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Most of the aforementioned components, in particular the identification unit, can be implemented in full or in part in the form of software modules in a processor of a suitable control device or of a processing system. An implementation largely in software has the advantage that even control devices and/or processing systems already in use can be easily upgraded by a software update in order to work in the manner according to at least one embodiment of the invention.

In an embodiment, the microgrid system comprises a microgrid bus electrically connected to an external grid, microgrid branches electrically connected to the microgrid bus, nanogrids electrically connected to the microgrid branches, and microgrid protection devices, including at least one of a protection device connected between the microgrid bus and the external grid, protection devices connected between the microgrid bus and the microgrid branches and protection devices connected between nanogrids and microgrid branches, and configured to break at least one of the electrical connection between the external grid and the microgrid bus, the electrical connections between the microgrid branches and the microgrid bus and the electrical connections between the nanogrids and the microgrid branches when at least one of the external grid, the microgrid bus and the microgrid branches malfunctions.

Therefore, the microgrid system in the example embodiments can operate in grid-connected mode in which it is connected with a conventional commercial grid, or in island mode in which it is disconnected from a conventional commercial grid and, in addition, the nanogrids in the microgrid system can operate in grid-connected mode in which they are connected with the energy storage unit in the microgrid system, or in island mode in which they are disconnected from the energy storage unit in the microgrid system. Furthermore, when a malfunction occurs in the microgrid system, some components in the microgrid system can be electrically disconnected through the operations of the microgrid protection devices, and thus the components in the microgrid system will be protected against the influence of the malfunction.

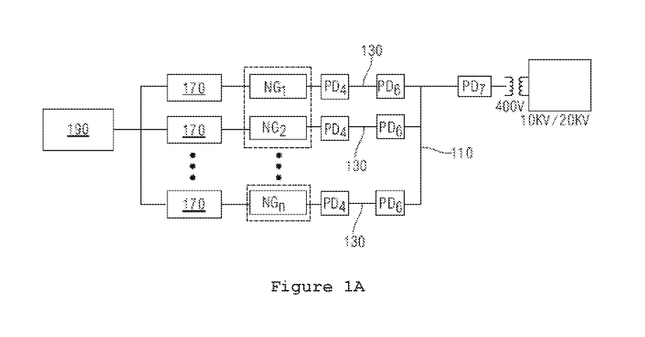

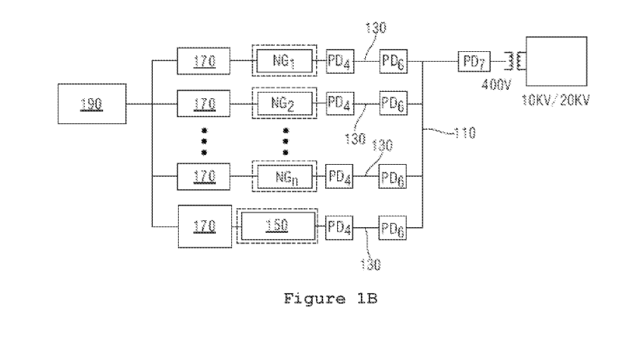

FIG. 1A and FIG. 1B are block diagrams for the microgrid systems in the example embodiments. As shown in FIG. 1A and FIG. 1B, the microgrid system in the example embodiments can be connected to an external grid via a transformer so that it can receive power from the external grid or provide power to the external grid. Here, the external grid can be a 10-kV to 20-kV medium-voltage grid, and the microgrid system in the example embodiments can be a 400-V low-voltage grid.

As shown in FIG. 1A and FIG. 1B, the microgrid system in the example embodiments can comprise a microgrid bus (110), microgrid branches (130) and nanogrids (NG) (NG1, NG2, . . . , NGn). The microgrid bus (110) can be electrically connected to an external grid, for example a medium-voltage grid, via a transformer. Microgrid branches (130) can be electrically connected to the microgrid bus (110). Each of the nanogrids (NG1, NG2, . . . , NGn) can be electrically connected to a microgrid branch (130). In addition, the microgrid system further comprises a nanogrid controller (170) and a central controller (190). The nanogrid controller (170) can control the operations of the nanogrids (NG1, NG2, . . . , NGn), respectively, and the central controller (190) can control the operations of the nanogrid controller (170).

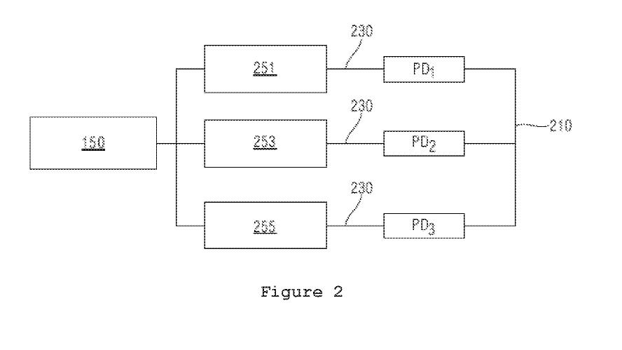

FIG. 2 is a block diagram for a nanogrid (NG) in an example embodiment. The nanogrid shown in FIG. 2 can be any of the nanogrids (NG1, NG2, . . . , NGn). As shown in FIG. 2, the nanogrid can comprise a nanogrid bus (210), nanogrid branches (230), and a distributed power supply (251), a nanogrid energy storage device (253) and a load (255). In addition, the nanogrid can further comprise a nanogrid control unit (270). The nanogrid control unit (270) can control the operations of the components in the nanogrid, respectively. The nanogrid bus (210) can be electrically connected to a microgrid branch (130). Nanogrid branches (230) can be electrically connected to the nanogrid bus (210). The distributed power supply (251), the nanogrid energy storage device (253) and the load (255) can be electrically connected to the nanogrid branches (230), respectively.

Here, the distributed power supply (251) can be a power supply providing a voltage below 100 kW, for example a solar battery or a wind turbine generator. The nanogrid energy storage device (253) can be an energy storage battery, for example. The load (255) can be civil electrical equipment, for example a household appliance or lighting equipment.

The nanogrid can operate in island mode. The distributed power supply (251) and/or the energy storage device (253) can supply power to the load (255).

The microgrid system shown in FIG. 1B can further comprise a microgrid energy storage device (150). The microgrid energy storage device (150) can be electrically connected to the microgrid branches. The microgrid energy storage device (150) can be an energy storage device having an output power of 100 kW to 1 MW, for example. Therefore, when the microgrid system is disconnected from the external grid, the microgrid can operate in island mode. The microgrid energy storage device (150) can supply power to nanogrids.

According to the example embodiments, the microgrid system can further comprise microgrid protection devices (PD) (PD1, PD2, PD3, PD4, PD6, PD7) connected between the microgrid and the external grid and/or connected between the components of the microgrid and/or nanogrids. The microgrid protection devices can break the electrical connection between related components when the microgrid and/or the external grid connected to the microgrid malfunctions, thus protecting the components of the microgrid system against the influence of the malfunction. The microgrid protection devices will be described in detail below. Here, the malfunction can include at least one of a current malfunction and a voltage malfunction, for example, overcurrent and overvoltage.

For example, the microgrid protection devices can include a first protection device (PD7) connected between the microgrid bus (110) and the external grid, second protection devices (PD4) connected between nanogrids (NG) and microgrid branches (130), and/or connected between the microgrid energy storage device (150) and microgrid branches (130), third protection devices (PD6) connected between microgrid branches (130) and the microgrid bus (110), and nanogrid protection devices (PD1, PD2, PD3) respectively connected between nanogrid branches (230) and the nanogrid bus (210). The microgrid protection devices can be a circuit breaker or fuse.

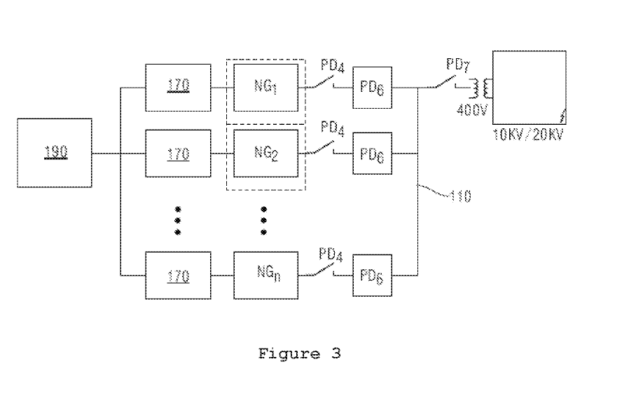

FIG. 3 through FIG. 21 are block diagrams for the malfunctions occurring in the microgrid systems in the example embodiments.

As shown in FIG. 3, when the external grid malfunctions, the first protection device (PD7) connected between the microgrid bus (110) and the external grid can break the electrical connection between the microgrid bus (110) and the external grid to protect the microgrid system against the influence of the malfunction of the external grid. Meanwhile, second protection devices (PD4) can break the electrical connections between the nanogrids and the microgrid branches (130). In this case, nanogrids can operate in island mode.

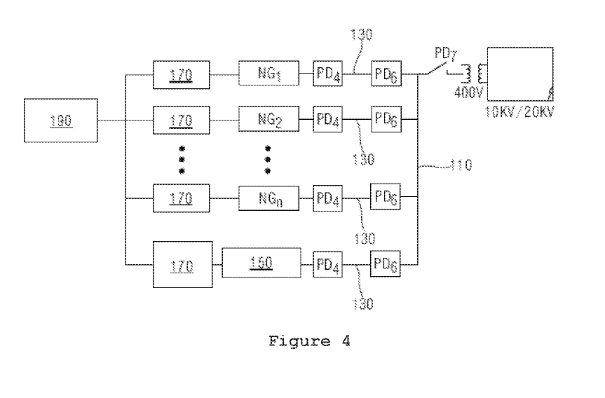

As shown in FIG. 4, when the microgrid system comprises a microgrid energy storage device (150) and the external grid malfunctions, the first protection device (PD7) connected between the microgrid bus (110) and the external grid can break the electrical connection between the microgrid bus (110) and the external grid to protect the microgrid system against the influence of the malfunction of the external grid. In this case, the microgrid system can operate in island mode. The microgrid energy storage device (150) can serve as a main power supply to maintain the voltage and frequency of the microgrid system.

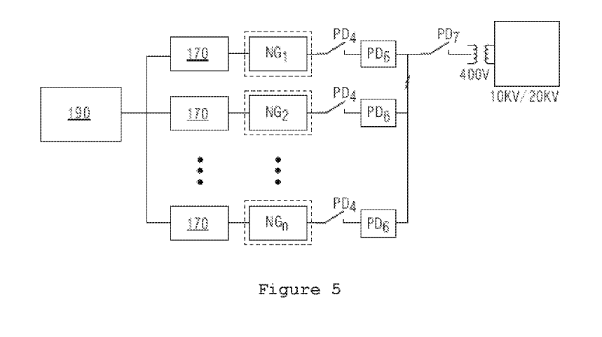

As shown in FIG. 5, when the microgrid bus (110) malfunctions, the first protection device (PD7) breaks the electrical connection between the microgrid bus (110) and the external grid and second protection devices (PD4) break the electrical connections between the nanogrids and the microgrid branches (130). In this case, the nanogrids can operate in island mode.

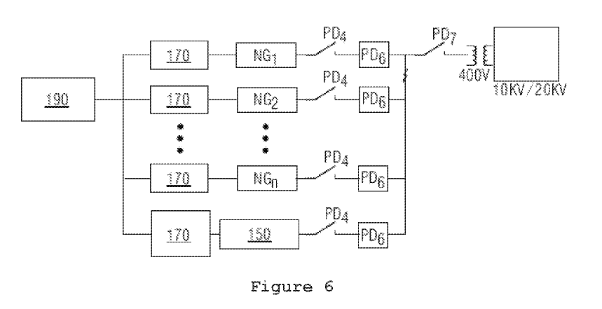

As shown in FIG. 6, when the microgrid system comprises a microgrid energy storage device (150) and the microgrid bus (110) malfunctions, the first protection device (PD7) can break the electrical connection between the microgrid bus (110) and the external grid and the second protection devices (PD4) can break the electrical connections between the nanogrids and the microgrid branches (130). In this case, the nanogrids can operate in island mode. In addition, the second protection devices (PD4) can further break the electrical connection between the microgrid energy storage device (150) and the microgrid branch (130). Here, the second protection device connected between the microgrid energy storage device (150) and the microgrid branches (130) can be called an energy storage protection device.

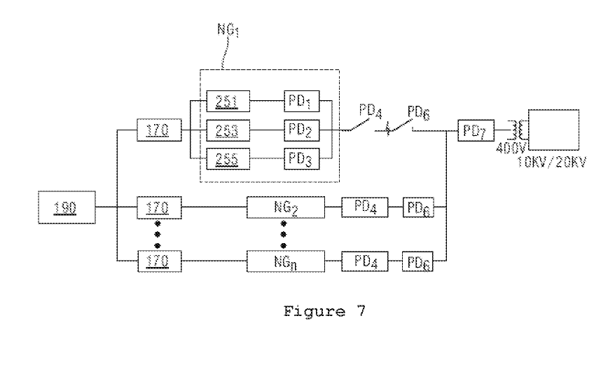

As shown in FIG. 7, when the microgrid branch (130) connected to the nanogrid (NG1) malfunctions, the second protection device (PD4) can break the electrical connection between the nanogrid (NG1) and the malfunctioning branch (130) and the third protection device (PD6) can break the electrical connection between the microgrid branch (130) and the microgrid bus (110). In this case, the nanogrid (NG1) electrically disconnected from the malfunctioning microgrid branch (130) can operate in island mode and the other nanogrids can normally operate in grid-connected mode.

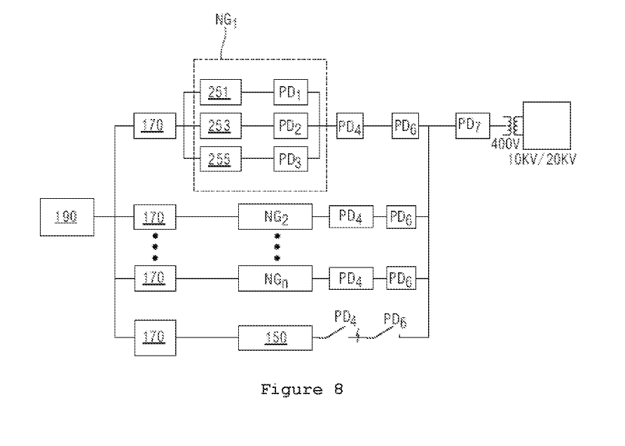

As shown in FIG. 8, when the microgrid system comprises a microgrid energy storage device (150) and the microgrid branch (130) connected to the microgrid energy storage device (150) malfunctions, the first protection device (PD4) can break the electrical connection between the microgrid energy storage device (150) and the malfunctioning microgrid branch (130). Meanwhile, the second protection device (PD6) can break the electrical connection between the microgrid branch (130) and the microgrid bus (110). In this case, the other nanogrids can normally operate in grid-connected mode. Here, the first protection device (PD4) connected between the microgrid energy storage device (150) and the microgrid branch (130) can be called the first energy storage protection device (PD4), and the second protection device (PD6) connected between the microgrid branch (130) connected to the microgrid energy storage device (150) and the microgrid bus (110) can be called the second energy storage protection device (PD6).

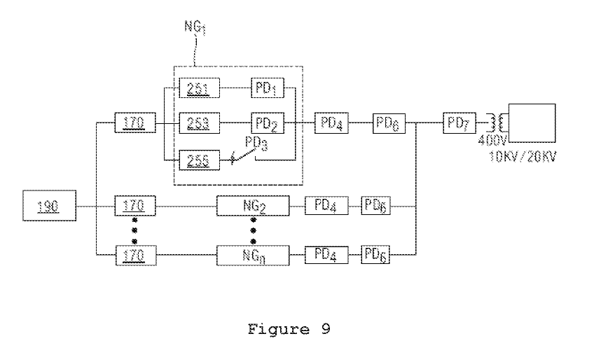

As shown in FIG. 9, when the nanogrid branch (230) connected to the load (255) in the nanogrid (NG1) malfunctions, the nanogrid protection device (PD3) connected between the nanogrid branch (230) connected to the load (255) and the nanogrid bus (210) can break the electrical connection between the nanogrid branch (230) connected to the load (255) and the nanogrid bus (210). In this case, the components other than the nanogrid (NG1) in the microgrid system operate normally.

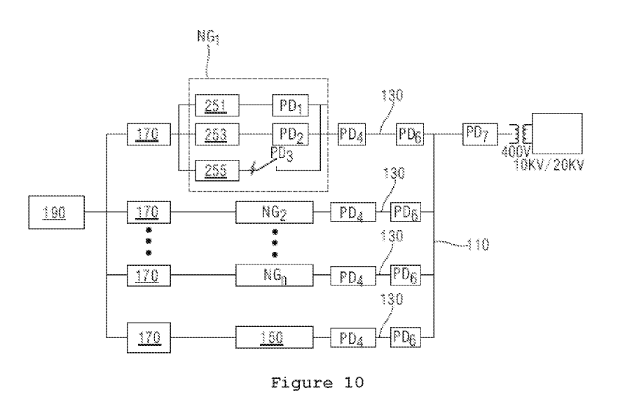

As shown in FIG. 10, when the microgrid system comprises a microgrid energy storage device (150) and the nanogrid branch (230) connected to the load (255) in the nanogrid (NG1) malfunctions, the nanogrid protection device (PD3) connected between the nanogrid branch (230) connected to the load (255) and the nanogrid bus (210) can break the electrical connection between the nanogrid branch (230) connected to the load (255) and the nanogrid bus (210). In this case, the components other than the nanogrid (NG1) in the microgrid system operate normally.

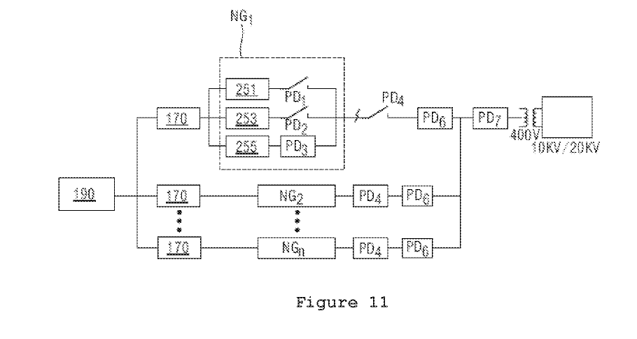

As shown in FIG. 11, when the nanogrid bus (210) malfunctions, the second protection device (PD4) can break the electrical connection between the nanogrid bus (210) and the microgrid branch (130). Meanwhile, the nanogrid protection device (PD1) connected between the nanogrid branch (230) connected to the distributed power supply (251) and the nanogrid bus (210) can break the electrical connection between the nanogrid branch (230) connected to the distributed power supply (251) and the nanogrid bus (210). And meanwhile, the nanogrid protection device (PD2) connected between the nanogrid branch (230) connected to the nanogrid energy storage protection device (253) and the nanogrid bus (210) can break the electrical connection between the nanogrid branch (230) connected to the nanogrid energy storage protection device (253) and the nanogrid bus (210). In this case, no power can be supplied to the load (255).

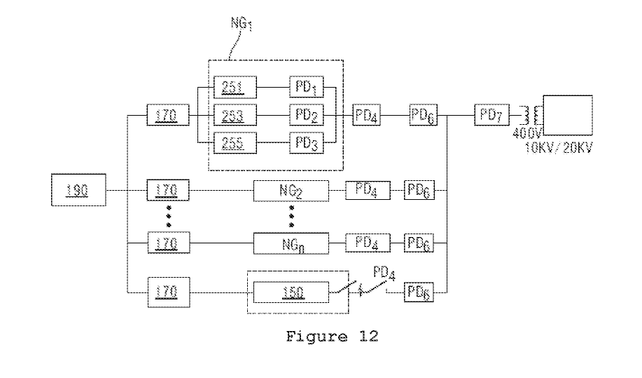

As shown in FIG. 12, when the microgrid system comprises a microgrid energy storage device (150) and the line connected between the microgrid energy storage device (150) and the first protection device (energy storage protection device) (PD4) malfunctions, the energy storage protection device (PD4) can break the electrical connection between the microgrid energy storage device (150) and the microgrid branch (130). In addition, the microgrid energy storage device (150) in the example embodiment can also comprise a protection device (PD). The protection device (PD) can be electrically connected between the energy storage unit (150) and the line between the microgrid energy storage device and the energy storage protection device. In this case, the other nanogrids can normally operate in grid-connected mode.

According to the example embodiments, the microgrid system shown in FIG. 1B can operate in island mode when electrically disconnected from the external grid.

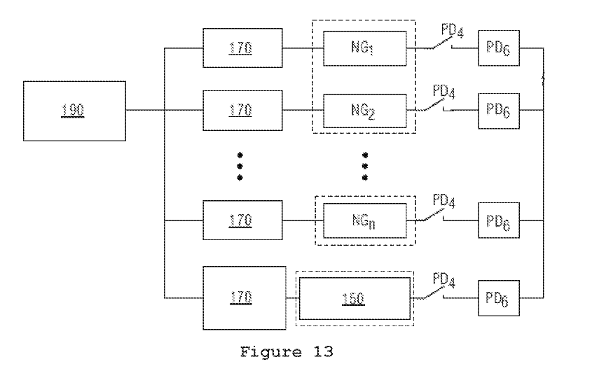

As shown in FIG. 13, when the microgrid system operates in island mode and the microgrid bus (110) malfunctions, the second protection devices (PD4) can break the electrical connections between the nanogrids and the microgrid branches (130) and the energy storage protection device (PD4) can break the electrical connection between the microgrid energy storage device (150) and the microgrid branch (130). In this case, each nanogrid can operate in island mode.

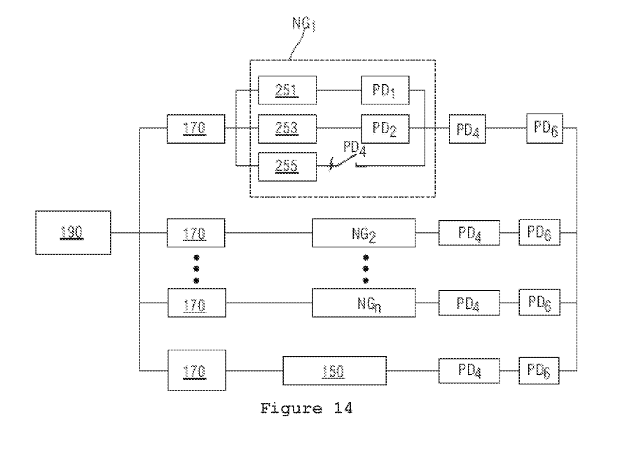

As shown in FIG. 14, when the microgrid system operates in island mode and the nanogrid branch (230) connected to the load (255) in the nanogrid (NG1) malfunctions, the nanogrid protection device (PD3) connected between the nanogrid branch (230) connected to the load (255) and the nanogrid bus (210) can break the electrical connection between the nanogrid branch (230) connected to the load (255) and the nanogrid bus (210). In this case, the other nanogrids can operate normally.

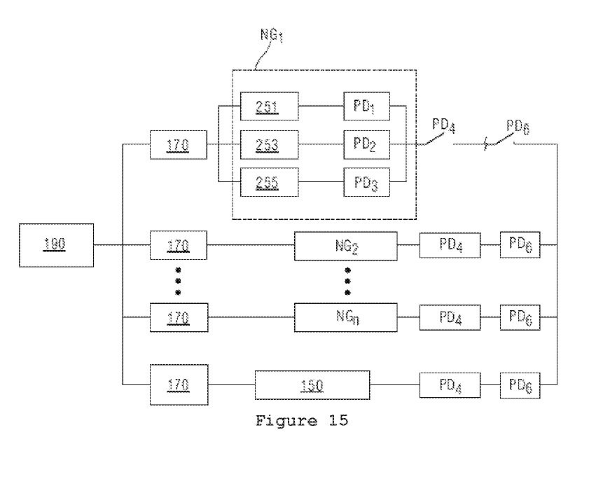

As shown in FIG. 15, when the microgrid system operates in island mode and the microgrid branch (130) connected to the nanogrid (NG1) malfunctions, the second protection device (PD4) can break the electrical connection between the nanogrid (NG1) and the microgrid branch (130) and the third protection device (PD6) can break the electrical connection between the microgrid branch (130) and the microgrid bus (110). In this case, the nanogrid (NG1) operates in island mode and the other nanogrids operate normally.

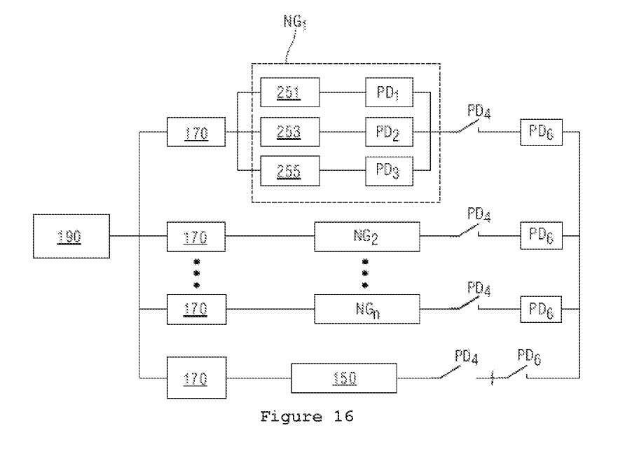

As shown in FIG. 16, when the microgrid system operates in island mode and the microgrid branch connected to the microgrid energy storage device (150) malfunctions, the second protection device (PD4) can break the electrical connection between the nanogrid and the microgrid branch (130), the energy storage protection device (PD4) can break the electrical connection between the microgrid energy storage device (150) and the microgrid branch (130), and the third protection device (PD4) can break the electrical connection between the microgrid branch (130) connected to the microgrid energy storage device (150) and the microgrid bus (110). In this case, all nanogrids can operate in island mode.

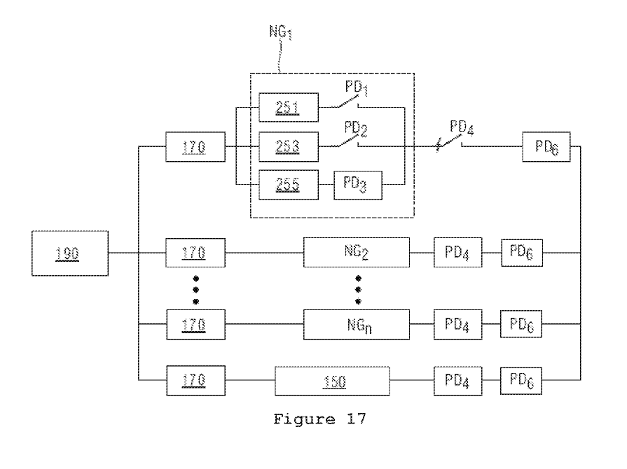

As shown in FIG. 17, when the microgrid system operates in island mode and the line connected between the nanogrid (NG1) and the second protection device (PD4) malfunctions, the second protection device (PD4) can break the electrical connection between the nanogrid (NG1) and the microgrid branch (130), the nanogrid protection device (PD1) connected between the nanogrid branch (230) connected to the distributed power supply (251) and the nanogrid bus (210) can break the electrical connection between the nanogrid branch (230) connected to the distributed power supply (251) and the nanogrid bus (210), and the nanogrid protection device (PD2) connected between the nanogrid branch (230) connected to the nanogrid energy storage device (253) and the nanogrid bus (210) can break the electrical connection between the nanogrid branch (230) connected to the nanogrid energy storage device (253) and the nanogrid bus (210). In this case, the nanogrid (NG1) stops operating and the other nanogrids operate normally.

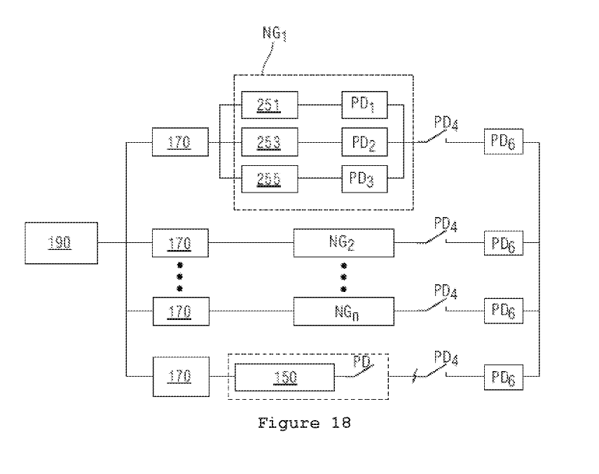

As shown in FIG. 18, when the microgrid system operates in island mode and the line connected between the microgrid energy storage device (150) and the energy storage protection device (PD4) malfunctions, the energy storage protection device (PD4) can break the electrical connection between the microgrid energy storage device (150) and the microgrid branch (130) and the second protection devices (PD4) can break the electrical connections between the nanogrids and the microgrid branches (130). In this case, all nanogrids can operate in island mode.

According to the example embodiments, the nanogrid shown in FIG. 2 can operate in island mode when electrically disconnected from the microgrid branch (130).

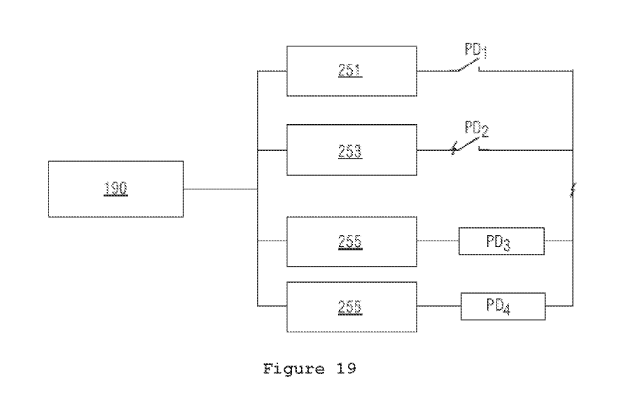

As shown in FIG. 19, when the nanogrid operates in island mode, the nanogrid bus (210) malfunctions and the nanogrid branch (230) connected to the nanogrid energy storage device (253) malfunctions, the nanogrid protection device (PD2) connected between the nanogrid branch (230) connected to the nanogrid energy storage device (253) and the nanogrid bus (210) can break the electrical connection between the nanogrid branch (230) connected to the nanogrid energy storage device (253) and the nanogrid bus (210), and the nanogrid protection device (PD1) connected between the nanogrid branch (230) connected to the distributed power supply (251) and the nanogrid bus (210) can break the electrical connection between the nanogrid branch (230) connected to the distributed power supply (251) and the nanogrid bus (210).

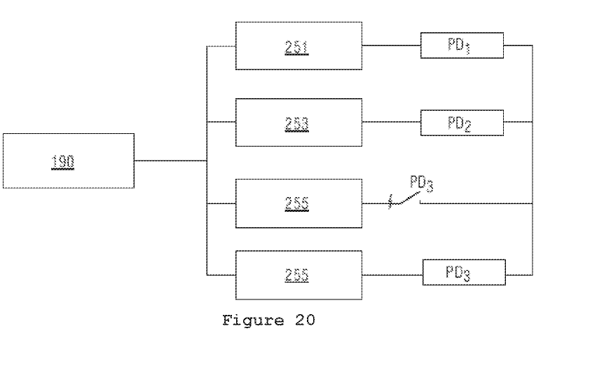

As shown in FIG. 20, when the nanogrid operates in island mode and the nanogrid branch (230) connected to a load (255) malfunctions, the nanogrid protection device (PD3) connected between the nanogrid branch (230) connected to the load (255) and the nanogrid bus (210) can break the electrical connection between the nanogrid branch (230) connected to the load (255) and the nanogrid bus (210). In this case, the other components of the nanogrid operate normally.

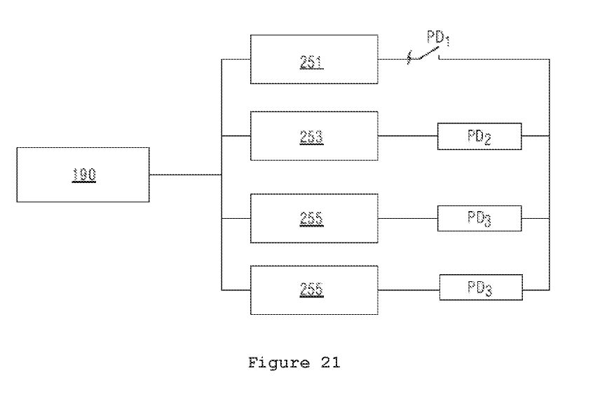

As shown in FIG. 21, when the nanogrid operates in island mode and the nanogrid branch (230) connected to the distributed power supply (251) malfunctions, the nanogrid protection device (PD1) connected between the nanogrid branch (230) connected to the distributed power supply (251) and the nanogrid bus (210) can break the electrical connection between the nanogrid branch (230) connected to the distributed power supply (251) and the nanogrid bus (210).

It should be understood that although the description gives a description by embodiment, this does not mean that each embodiment contains only one independent technical solution. The description method in the description is only for the sake of clarity. Those skilled in the art should consider the description as an integral body. The technical solutions in all these embodiments can be suitably combined to form other embodiments that those skilled in the art can understand.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

The above are only example embodiments of the present invention, and are not used to limit the scope of the present invention. All equivalent variations, modifications, or combinations made by any person skilled in the art without departing from the conception and principle of the present invention should fall within the scope of protection of the present invention.

What is claimed is:

1. A microgrid system, comprising:
a microgrid bus, electrically connected to an external grid;
microgrid branches, electrically connected to the microgrid bus;
nanogrids, electrically connected to the microgrid branches; and
microgrid protection devices, each of the microgrid protection devices including at least one of a protection device connected between the microgrid bus and the external grid, protection devices connected between the microgrid branches and the microgrid bus and protection devices connected between nanogrids and microgrid branches, each of the microgrid protection devices being configured to break at least one of an electrical connection between the microgrid bus and the external grid, electrical connections between the microgrid branches and the microgrid bus and an electrical connections between the nanogrids and the microgrid branches upon at least one of the external grid, the microgrid bus and the microgrid branches malfunctioning.

2. The microgrid system of claim 1, wherein each of the microgrid protection devices include:
a first protection device, connected between the microgrid bus and the external grid, wherein upon the external grid malfunctioning, the first protection device is configured to break the electrical connection between the microgrid bus and the external grid.

3. The microgrid system of claim 2, wherein each of the microgrid protection devices further include:
second protection devices, connected between the nanogrids and the microgrid branches, wherein upon the external grid malfunctioning, the second protection devices are configured to break the electrical connections between the nanogrids and the microgrid branches.

4. The microgrid system of claim 2, further comprising:
a microgrid energy storage device, electrically connected to the microgrid branches, wherein upon the first protection device breaking the electrical connection between the microgrid bus and the external grid, the microgrid system is configured to operate in island mode.

5. The microgrid system of claim 1, wherein the microgrid protection devices include:
a first protection device, connected between the microgrid bus and the external grid, and
second protection devices, each respectively connected between respective ones of the nanogrids and respective ones of the microgrid branches, wherein upon the microgrid bus malfunctioning, the first protection device is configured to break the electrical connection between the microgrid bus and the external grid and the second protection devices are configured to break the respective electrical connections between respective ones of the nanogrids and respective ones of the microgrid branches.

6. The microgrid system of claim 5, further comprising:
a microgrid energy storage device, electrically connected to a respective one of the microgrid branches, wherein the microgrid protection devices each include an energy storage protection device connected between a respective one of the microgrid energy storage devices and a respective one of the microgrid branches, and upon the microgrid bus malfunctioning, the first protection device is configured to break the electrical connection between the microgrid bus and the external grid, the second protection devices are configured to break the electrical connections between the nanogrids and the respective one of the microgrid branches, and the energy storage protection device is configured to break the electrical connection between the respective one of the microgrid energy storage devices and the respective one of the microgrid branches.

7. The microgrid system of claim 1, wherein the microgrid protection devices each include:
second protection devices, connected between respective ones of the nanogrids and respective ones of the microgrid branches, and
third protection devices, connected between respective ones of the microgrid branches and the microgrid bus, wherein upon one of the microgrid branches malfunctioning, the second protection device is configured to break the electrical connection between a respective one of the nanogrid and a respective one of the microgrid branches and the third protection device is configured to break the electrical connection between the respective one of the microgrid branches and the microgrid bus.

8. The microgrid system of claim 1, further comprising:
a microgrid energy storage device, electrically connected to a respective one of the microgrid branches, wherein the microgrid protection devices each include a first energy storage protection device connected between the microgrid energy storage device and a respective one of the microgrid branches and a second energy storage protection device connected between the respective one of the microgrid branches and the microgrid bus, and upon the respective one of the microgrid branches connected to the microgrid energy storage device malfunctioning, the first energy storage protection device is configured to break the electrical connection between the microgrid energy storage device and the respective one of the microgrid branches and the second energy storage protection device is configured to break the electrical connection between the respective one of the microgrid branches and the microgrid bus.

9. The microgrid system of claim 1, wherein each of the nanogrids comprises:
a nanogrid bus, electrically connected to a respective one of the microgrid branches,
nanogrid branches, electrically connected to the nanogrid bus, and
a distributed power supply, a nanogrid energy storage device and a load, each respectively electrically connected to the nanogrid branches, wherein the microgrid protection devices include nanogrid protection devices each respectively connected between respective ones of the nanogrid branches and the nanogrid bus, and upon a respective one of the nanogrid branches respectively connected to the load malfunctioning, the nanogrid protection device connected between the respective one of the nanogrid branches connected to the load and the nanogrid bus being configured to break the electrical connection between the respective one of the nanogrid branches connected to the load and the nanogrid bus.

10. The microgrid system of claim 9, further comprising:
a microgrid energy storage device, electrically connected to a microgrid branch.

11. The microgrid system of claim 1, wherein each of the nanogrids comprises:
a nanogrid bus, electrically connected to a respective one of the microgrid branches,
nanogrid branches, electrically connected to the nanogrid bus, and
a distributed power supply, a nanogrid energy storage device and a load, each respectively electrically connected to the nanogrid branches, wherein the microgrid protection devices each include a second protection device connected between the nanogrid bus and the respective one of the microgrid branches and nanogrid protection devices connected between the nanogrid branches and the nanogrid bus, and upon the nanogrid bus malfunctioning, the second protection device is configured to break the electrical connection between the nanogrid bus and the respective one of the microgrid branches, the nanogrid protection device connected between the nanogrid branch connected to the distributed power supply and the nanogrid bus is configured to break the electrical connection between the nanogrid branch connected to the distributed power supply and the nanogrid bus, and the nanogrid protection device connected between the nanogrid branch connected to the nanogrid energy storage device and the nanogrid bus is configured to break the electrical connection between the nanogrid branch connected to the nanogrid energy storage device and the nanogrid bus.

12. The microgrid system of claim 1, further comprising:
a microgrid energy storage device, electrically connected to a respective one of the microgrid branches, wherein the microgrid protection devices include an energy storage protection device connected between the microgrid energy storage device and a respective one of the microgrid branches, and upon the line connected between the microgrid energy storage device and the energy storage protection device malfunctioning, the energy storage protection device is configured to break the electrical connection between the microgrid energy storage device and the respective one of the microgrid branches.

13. The microgrid system of claim 12, wherein the microgrid energy storage device comprises:
an energy storage unit, electrically connected to the energy storage protection device, and
a protection device, connected between the energy storage unit and the line between the microgrid energy storage device and the energy storage protection device, wherein upon the line connected between the microgrid energy storage device and the energy storage protection device malfunctioning, the protection device of the microgrid energy storage device is configured to break the electrical connection between the energy storage unit and the line between the microgrid energy storage device and the energy storage protection device.

14. The microgrid system of claim 1, further comprising:
a microgrid energy storage device, electrically connected to a respective one of the microgrid branches, wherein upon the microgrid bus being electrically disconnected from the external grid, the microgrid system is configured to operate in island mode.

15. The microgrid system of claim 14, wherein the microgrid protection devices each include:
second protection devices, each respectively connected between a respective one of the nanogrids and a respective one of the microgrid branches, and
an energy storage protection device, connected between the microgrid energy storage device and a respective one of the microgrid branches, wherein upon the microgrid system operating in the island mode and the microgrid bus malfunctioning, the second protection devices are each respectively configured to break the electrical connections between the respective one of the nanogrids and the respective one of the microgrid branches and the energy storage protection device is configured to break the electrical connection between the microgrid energy storage device and the respective one of the microgrid branches.

16. The microgrid system of claim 14, wherein each of the nanogrids comprises:
a nanogrid bus, electrically connected to a respective one of the microgrid branches,
nanogrid branches, electrically connected to the nanogrid bus, and
a distributed power supply, a nanogrid energy storage device and a load, each respectively electrically connected to a respective one of the nanogrid branches, wherein the microgrid protection devices include the respective nanogrid protection devices connected between the respective nanogrid branches and the nanogrid bus, and upon the microgrid system operating in the island mode and the nanogrid branch connected to the load malfunctioning, the respective nanogrid protection device connected between the nanogrid branch connected to the load and the nanogrid bus is configured to the electrical connection between the nanogrid branch connected to the load and the nanogrid bus.

17. The microgrid system of claim 14, wherein the microgrid protection devices each include:
second protection devices, connected between the nanogrids and the microgrid branches, and
third protection devices, connected between the microgrid branches and the microgrid bus, wherein upon the microgrid system operating in the island mode and a microgrid branch connected to a nanogrid malfunctioning, the second protection device is configured to break the electrical connection between the nanogrid and the microgrid branch and the third protection device is configured to break the electrical connection between the microgrid branch and the microgrid bus.

18. The microgrid system of claim 17, wherein the microgrid protection devices each include:
second protection devices, connected between the nanogrids and the microgrid branches,
an energy storage protection device, connected between the microgrid energy storage device and a microgrid branch, and
a third protection device, connected between the microgrid branch connected to the microgrid energy storage device and the microgrid bus, wherein upon the microgrid system operating in the island mode and the microgrid branch connected to the microgrid energy storage device malfunctioning, the second protection device is configured to break the electrical connection between the nanogrid and the microgrid branch, the energy storage protection device is configured to break the electrical connection between the microgrid energy storage device and the microgrid branch, and the third protection device is configured to break the electrical connection between the microgrid branch connected to the microgrid energy storage device and the microgrid bus.

19. The microgrid system of claim 14, wherein each of the nanogrids comprises:
a nanogrid bus, electrically connected to a respective one of the microgrid branches,
nanogrid branches, electrically connected to the nanogrid bus, and
a distributed power supply, a nanogrid energy storage device and a load, each respectively electrically connected to the respective nanogrid branches, wherein the microgrid protection devices include the second protection device connected between the nanogrid and the respective one of the microgrid branches, and the nanogrid protection devices connected between nanogrid branches and the nanogrid bus, and upon the microgrid system operating in the island mode and the line connected between a nanogrid and a second protection device malfunctioning, the second protection device is configured to break the electrical connection between the nanogrid and the respective one of the microgrid branches, the nanogrid protection device connected between the nanogrid branch connected to the distributed power supply and the nanogrid bus is configured to break the electrical connection between the nanogrid branch connected to the distributed power supply and the nanogrid bus, and the nanogrid protection device connected between the nanogrid branch connected to the nanogrid energy storage device and the nanogrid bus is configured to break the electrical connection between the nanogrid branch connected to the nanogrid energy storage device and the nanogrid bus.

20. The microgrid system of claim 14, wherein the microgrid protection devices each include:
second protection devices, connected between the nanogrids and the microgrid branches, and
an energy storage protection device, connected between the microgrid energy storage device and a respective one of the microgrid branches, wherein upon the microgrid system operating in the island mode and the line connected between the microgrid energy storage device and the energy storage protection device malfunctioning, the energy storage protection device is configured to break the electrical connection between the microgrid energy storage device and the respective one of the microgrid branches and the respective second protection devices is configured to break the electrical connections between the nanogrids and the respective microgrid branches.

21. The microgrid system of claim 20, wherein the microgrid energy storage device comprises:
an energy storage unit, electrically connected to the energy storage protection device, and
a protection device, connected between the energy storage unit and the line between the microgrid energy storage device and the energy storage protection device, wherein upon the microgrid system operating in the island mode and the line connected between the microgrid energy storage device and the energy storage protection device malfunctioning, the protection device of the microgrid energy storage device is configured to break the electrical connection between the energy storage unit and the line between the microgrid energy storage device and the energy storage protection device.

22. The microgrid system of claim 1, wherein each of the nanogrids comprises:
a nanogrid bus, electrically connected to a microgrid branch,
nanogrid branches, electrically connected to the nanogrid bus, and
a distributed power supply, a nanogrid energy storage device and a load, each respectively electrically connected to a respective one of the nanogrid branches, wherein upon the nanogrid being electrically disconnected from the respective one of the microgrid branches, the nanogrid is configured to operate in an island mode.

23. The microgrid system of claim 22, wherein the microgrid protection devices each include:
nanogrid protection devices, connected between the nanogrid branches and the nanogrid bus, wherein upon the nanogrid operating in the island mode, the nanogrid bus malfunctioning and the nanogrid branch connected to the nanogrid energy storage device malfunctioning, the nanogrid protection device connected between the nanogrid branch connected to the nanogrid energy storage device and the nanogrid bus is configured to break the electrical connection between the nanogrid branch connected to the nanogrid energy storage device and the nanogrid bus, and the nanogrid protection device connected between the nanogrid branch connected to the distributed power supply and the nanogrid bus is configured to break the electrical connection between the nanogrid branch connected to the distributed power supply and the nanogrid bus.

24. The microgrid system of claim 22, wherein each of the microgrid protection devices include:
nanogrid protection devices, connected between the nanogrid branches and the nanogrid bus, wherein upon the nanogrid operating in the island mode and the nanogrid branch connected to the load malfunctioning, the nanogrid protection device connected between the nanogrid branch connected to the load and the nanogrid bus is configured to break the electrical connection between the nanogrid branch connected to the load and the nanogrid bus.

25. The microgrid system of claim 22, wherein each of the microgrid protection devices include:
nanogrid protection devices, connected between the nanogrid branches and the nanogrid bus, wherein upon the nanogrid operating in the island mode and the nanogrid branch connected to the distributed power supply malfunctioning, the nanogrid protection device connected between the nanogrid branch connected to the distributed power supply and the nanogrid bus is configured to break the electrical connection between the nanogrid branch connected to the distributed power supply and the nanogrid bus.
